(19) United States
(12) Patent Application Publication
(10) Pub. No.: US 2025/0074081 A1
(43) Pub. Date: Mar. 6, 2025

(54) LIQUID EJECTION APPARATUS AND LIQUID EJECTION METHOD

(71) Applicant: SEIKO EPSON CORPORATION, Tokyo (JP)

(72) Inventors: Yohei SHIBATA, SHIOJIRI-SHI (JP); Junya KATO, MATSUMOTO-SHI (JP); Yohei NUNOKAWA, SHIOJIRI-SHI (JP)

(21) Appl. No.: 18/826,513

(22) Filed: Sep. 6, 2024

(30) Foreign Application Priority Data
Sep. 6, 2023 (JP) 2023-144218

(51) Int. Cl. B41J 11/00; B41J 25/00; B41J 29/00

(52) U.S. Cl. CPC B41J 11/008; B41J 11/00242; B41J 11/0035; B41J 11/0095; B41J 25/001; B41J 29/00

(57) ABSTRACT

A printer includes a glue belt on which a plurality of different types of media are arranged, an ejection head that ejects ink to the plurality of media while reciprocating along an X-axis direction, a first detection unit that detects an end portion of the medium, a second detection unit that detects a thickness of the medium, and a control unit, and the control unit causes the first detection unit to detect an end portion of each of the plurality of media, sets an ejection range in which the ink is ejected for each medium based on a detection result of the first detection unit, causes the second detection unit to detect a thickness of each of the plurality of media, and determines an adjustment amount for adjusting the landing position of the ink for each medium based on a detection result of the second detection unit, and adjusts the landing position based on the adjustment amount and causes the ink to be ejected in the ejection ranges of the plurality of media from the ejection head.

The present application is based on, and claims priority from JP Application Serial Number 2023-144218, filed Sep. 6, 2023, the disclosure of which is hereby incorporated by reference herein in its entirety.

### BACKGROUND

### 1. Technical Field

The present disclosure relates to a liquid ejection apparatus and a liquid ejection method.

### 2. Related Art

In a printer that performs printing by ejecting liquid from an ejection head onto a medium while causing a carriage on which the ejection head is mounted to reciprocate, there is a time difference between a timing at which the liquid is ejected and the timing at which the liquid lands on the medium. When bidirectional printing is performed in such a printer, a deviation corresponding to a distance between the ejection head and the medium may occur between the landing position in a forward path and the landing position in a backward path. To this end, Japanese Patent Application Publication No. 2009-61755 proposes a printer capable of adjusting a timing of ejecting liquid depending on the distance between the ejection head and the medium when performing bidirectional printing.

In a printer that prints an image such as a pattern on a relatively large medium such as a fabric, the same image may be printed on a plurality of different types of media in order to create a sample for selecting an appropriate medium from various types of media. Since such a sample may have a relatively small size, productivity at the time of creating the sample is increased when a plurality of media can be arranged in the moving direction of the carriage. However, in the configuration described in Japanese Patent Application Publication No. 2009-61755, it is not assumed that printing is performed on a plurality of media arranged in the moving direction of the carriage. To this end, when the thicknesses of the arranged media are different from each other, the distance between the ejection head and the medium is different for each medium and, therefore, the image is disturbed due to the deviation of the landing position in at least one of the media. That is, there is a demand for a printer capable of curbing the deviation of the landing position for each medium even when a plurality of media having different thicknesses are arranged in a movement direction of the carriage.

### SUMMARY

A liquid ejection apparatus includes a support member on which a plurality of different types of media are arranged, an ejection head configured to eject liquid onto the plurality of media while reciprocating along a first direction, a first detection unit configured to detect an end portion of the medium arranged on the support member, a second detection unit configured to detect a thickness of the medium arranged on the support member, and a control unit, wherein the control unit causes the first detection unit to detect an end portion of each of the plurality of media, sets an ejection range in which the liquid is ejected for each medium based on a detection result of the first detection unit, causes the second detection unit to detect a thickness of each of the plurality of media, and determines an adjustment amount for adjusting a landing position of the liquid for each medium based on a detection result of the second detection unit, and adjusts the landing position based on the adjustment amount and causes the liquid to be ejected in the ejection ranges of the plurality of media from the ejection head.

A liquid ejection method is a liquid ejection method using a liquid ejection apparatus including an ejection head configured to eject liquid onto a plurality of different types of media arranged on a support member while reciprocating in a first direction, a first detection unit configured to detect an end portion of the media arranged on the support member, and a second detection unit configured to detect a thickness of the media arranged on the support member, the liquid ejection method including: causing the first detection unit to detect an end portion of each of the plurality of media; setting an ejection range in which the liquid is ejected for each medium based on a detection result of the first detection unit; causing the second detection unit to detect a thickness of each of the plurality of media; determining an adjustment amount for adjusting a landing position of the liquid for each medium based on a detection result of the second detection unit; and adjusting the landing position based on the adjustment amount and causing the liquid to be ejected onto the ejection ranges of the plurality of media from the ejection head.

### BRIEF DESCRIPTION OF THE DRAWINGS

FIG. 1 is a schematic cross-sectional view showing a configuration of a printer.

FIG. 2 is a plan view of a main part of the printer.

FIG. 3A is a side view illustrating a deviation of landing positions in bi-directional printing.

FIG. 3B is a side view illustrating a deviation of landing positions in the bi-directional printing.

FIG. 4 is a block diagram showing an electrical configuration of the printer.

FIG. 5 is a plan view illustrating a state in which three media are arranged on a glue belt according to a first embodiment.

FIG. 6 is a flowchart illustrating a printing operation of the printer according to the first embodiment.

FIG. 7 is a plan view illustrating a state in which three media are arranged on a glue belt according to a second embodiment.

FIG. 8 is a flowchart illustrating a printing operation of the printer according to the second embodiment.

FIG. 9 is a plan view of a main part of a printer according to a modification example when viewed from above.

### DESCRIPTION OF EMBODIMENTS

### 1. First Embodiment

Hereinafter, a schematic configuration of a printer 10 of a first embodiment will be described.

The printer 10 of the present embodiment is an inkjet printer that ejects ink onto a medium M such as fabric, and prints an image such as patterns. The printer 10 is an example of a liquid ejection apparatus, and the ink is an example of a liquid.

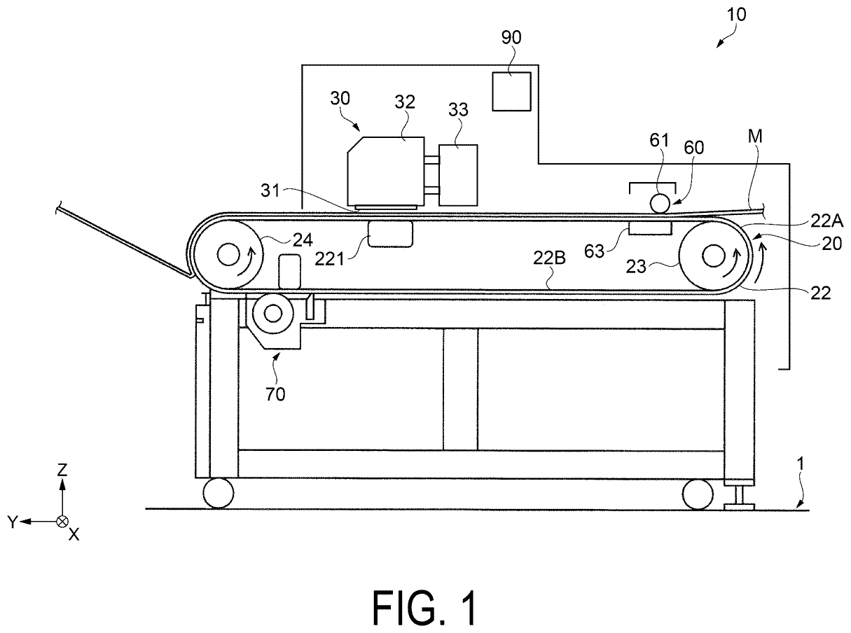

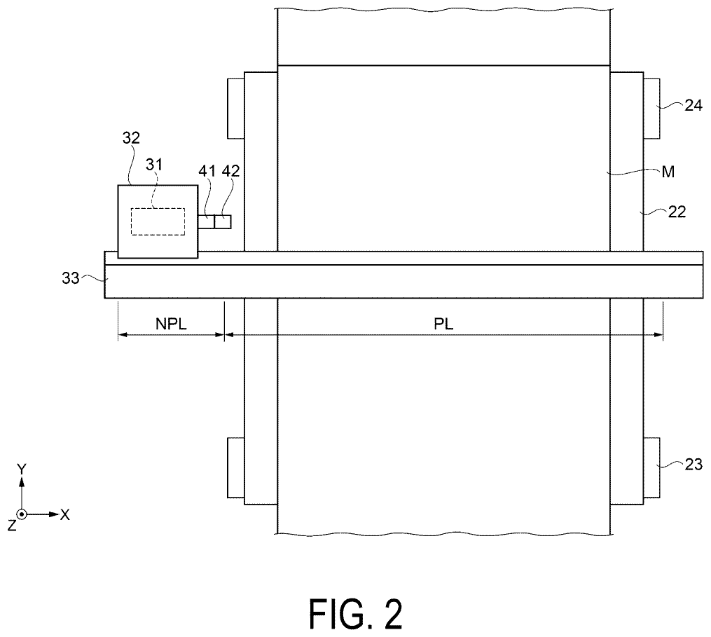

FIG. 1 is a schematic cross-sectional view showing a configuration of the printer 10 of the present embodiment, and FIG. 2 is a plan view of main parts of the printer 10 viewed from above.

In FIGS. 1 and 2, scales of respective members are different from the actual scales in order to make the members large enough to be recognizable. In FIGS. 1 and 2, an X-axis, a Y-axis, and a Z-axis are illustrated as three axes orthogonal to each other.

The X-axis is an axis parallel to an installation surface of the printer 10, and corresponds to a width direction of the printer 10. A +X direction parallel to the X-axis is a direction from the back to the front of the printer 10 when a driving roller 24 to be described later is disposed to the left of the printing unit 30 to be described later. In the case of FIG. 1, a +X direction is a backward direction in the figure. A −X direction parallel to the X-axis is a direction opposite to the +X direction. The +X direction corresponds to a first direction.

The Y-axis is an axis parallel to the installation surface 1 of the printer 10 and corresponds to a depth direction of the printer 10. The +Y direction parallel to the Y-axis is a direction from the driven roller 23 to be described later toward the driving roller 24 to be described later. In the case of FIG. 1, a +Y direction is a leftward direction in the figure. A −Y direction parallel to the Y-axis is a direction opposite to the +Y direction. Further, the +Y direction corresponds to a transport direction of the medium M.

The Z-axis is an axis perpendicular to the installation surface of the printer 10, that is, an axis along a gravity direction in which gravity acts, and corresponds to a height direction of the printer 10. A +Z direction parallel to the Z-axis is an upward direction from the installation surface of the printer 10. In the case of FIG. 1, the +Z direction is a direction toward the top of the figure. A −Z direction parallel to the Z-axis is a direction opposite to the +Z direction.

Hereinafter, a direction parallel to the X-axis is referred to as “X-axis direction”, a direction parallel to the Y-axis as “Y-axis direction”, and a direction parallel to the Z-axis as “Z-axis direction”. That is, the X-axis direction includes both the +X direction and the −X direction, the Y-axis direction includes both the +Y direction and the −Y direction, and the Z-axis direction includes both the +Z direction and the −Z direction.

As shown in FIG. 1, the printer 10 includes a transport unit 20 that transports the medium M, the printing unit 30 that performs printing on the medium M to be transported, a pressing unit 60 that presses the medium M against a transport belt, and a cleaning unit 70 that cleans the transport belt. Further, the printer 10 includes a controlling unit 90 that controls each of these components. In the present embodiment, the medium M is fabric such as that of cotton, silk, wool, chemical fibers, and mixed fibers.

The transport unit 20 includes a glue belt 22, a platen 221, a driven roller 23, a driving roller 24, and the like. The transport unit 20 transports the long medium M unwound from a supply roller (not illustrated) in the +Y direction.

The glue belt 22 is an example of the transport belt capable of transporting the medium M and is configured as an endless belt obtained by joining both ends of a flat plate having elasticity. The glue belt 22 is a rubber belt, and is wound around the driven roller 23 and the driving roller 24. The glue belt 22 transports the medium M in the +Y direction by being circularly moved by driving of the driving roller 24.

An outer circumferential surface 22A of the glue belt 22 has adhesiveness by being coated with an adhesive, and supports the medium M through this adhesiveness. The “adhesiveness” refers to a property of be capable of temporarily adhering to other members and allowing peeling-off from an adhesion state. This makes it possible for stretchable fabric or the like to be handled as the printable medium P. The glue belt 22 is an example of the support member that supports the medium M. A color of the outer circumferential surface 22A of the glue belt 22 is a dark color such as black.

The glue belt 22 that supports the medium M passes between the ejection head 31 to be described below and a platen 221 disposed on the −Z side of the ejection head 31. The ejection head 31 ejects the ink onto the medium M transported on the platen 221 to form an image on the medium M.

The medium M onto which the ink is ejected from the ejection head 31 is wound by a winding roller (not illustrated), and is thereby peeled off from a portion of the outer circumferential surface 22A of the glue belt 22 that is wound around the driving roller 24.

The driven roller 23 and the driving roller 24 support an inner circumferential surface 22B of the glue belt 22. The driving roller 24 is driven to rotate by the transport motor (not illustrated). When the driving roller 24 is driven to rotate, the glue belt 22 circulates with the rotation of the driving roller 24, and then the driven roller 23 is driven to rotate due to the circulation of the glue belt 22.

The glue belt 22 circulates in a counterclockwise direction in FIG. 1 due to the rotation of the driving roller 24, to transport the medium M supported on the outer circumferential surface 22A in a transport direction which is the +Y direction. In the present embodiment, a path along which the glue belt 22 circulates in the counterclockwise direction is hereinafter referred to as a circulation path. In the circulation path, a path along which the medium M is transported is referred to as a transport path, and the other paths, that is, paths that do not constitute the transport path of the medium M are referred to as a transport preparation path. Therefore, the transport path is a path from a position at which the unwound medium M is pressed by the pressing unit 60 to be described below and is supported by the glue belt 22 to a position at which the printing ends and the medium M is peeled off from the glue belt 22.

In the transport path, the outer circumferential surface 22A of the circulating glue belt 22 faces the +Z direction side facing the printing unit 30. The glue belt 22 moves from the driven roller 23 side to the driving roller 24 side while supporting the medium M. Further, in the transport preparation path, the outer circumferential surface 22A of the circulating glue belt 22 faces the −Z direction side facing the cleaning unit 70 to be described below. Only the glue belt 22 from which the medium M is peeled moves from the driving roller 24 side to the driven roller 23 side.

The pressing unit 60 presses the medium M against the glue belt 22 to bring the medium M into close contact therewith. The pressing unit 60 is provided on the side in the +Y direction downstream of the driven roller 23 on the side in the −Y direction upstream of the printing unit 30 in the transport direction. The pressing unit 60 includes a pressing roller 61, a roller support portion 63, and a pressing roller driving unit (not illustrated).

The pressing roller 61 is formed in a cylindrical shape or a columnar shape, and is provided rotatably in a circumferential direction along a cylindrical surface of the pressing roller 61 using a roller shaft (not shown) along the X-axis direction as a rotation axis. The roller support portion 63 is provided at a position facing the pressing roller 61 with the glue belt 22 interposed therebetween on the inner circumferential surface 22B side of the glue belt 22.

A length of the pressing roller 61 in the X-axis direction is substantially the same as the length of the glue belt 22 in the X-axis direction. A length of the medium M in the X-axis direction is smaller than the lengths of the pressing roller 61 and the glue belt 22 in the X-axis direction. Further, a length of the roller support portion 63 in the X-axis direction is approximately the same as the length of the pressing roller 61 in the X-axis direction.

The pressing roller 61 is pressed downward, that is, in the −Z direction by the pressing roller driving unit. The pressed pressing roller 61 rotates with the movement of the glue belt 22 in the transport direction. The medium M superimposed on the glue belt 22 is pressed onto the glue belt 22 between the press roller 61 and the roller support portion 63. Through the operation of the pressing unit 60, the medium M can be adhered to the glue belt 22, and the occurrence of floating of the medium M on the glue belt 22 can be curbed.

The printing unit 30 is disposed in an upward direction, that is, in the +Z direction with respect to the glue belt 22 moving in the +Y direction which is the transport direction, and performs printing on the medium M supported on the outer circumferential surface 22A of the glue belt 22. The printing unit 30 includes the ejection head 31, a carriage 32, and a carriage guide 33. The ejection head 31 ejects ink onto the medium M supported by the glue belt 22.

The carriage guide 33 extends in the X-axis direction and supports the carriage 32. One or a plurality of ejection heads 31 are disposed in the carriage 32. The carriage guide 33 is formed so that the length thereof in the X-axis direction is larger than the length of the glue belt 22 in the X-axis direction. The carriage 32 is configured to be able to reciprocate in the X-axis direction while being supported by the carriage guide 33. Hereinafter, in a path along which the carriage 32 reciprocates in the X-axis direction, a path along which the carriage 32 moves in the +X direction is also referred to as a forward path, and a path along which the carriage 32 moves in the −X direction is also referred to as a backward path.

One or a plurality of nozzle arrays (not shown) made up of a plurality of nozzles for ejecting ink are formed in the ejection head 31. The nozzle array faces the medium M transported by the glue belt 22. The ejection head 31 forms an image on the medium M by ejecting ink from the nozzle array onto the medium M transported on the platen 221 while reciprocating in the X-axis direction together with the carriage 32.

As shown in FIG. 2, the carriage 32 is movable between a printable region PL in which printing on the medium M is possible in the X-axis direction and a retraction region NPL outside the printable region PL in the X-axis direction. In the present embodiment, the retraction region NPL is provided on the −X direction side of the printable region PL. The retraction region NPL is, for example, an area in which maintenance of the ejection head 31 is performed.

The printer 10 intermittently transports the medium M in close contact with the glue belt 22 in the transport direction by intermittently moving the glue belt 22. The printer 10 performs printing on the medium M that is intermittently transported. Specifically, the printer 10 forms an image on the medium M by alternately performing the operation of ejecting the ink from the ejection head 31 while moving the carriage 32 along the X-axis direction and the operation of transporting the medium M by a predetermined amount in the transport direction using the transport unit 20.

The printer 10 of the present embodiment is capable of executing bidirectional printing using the ejection head 31. That is, the ejection head 31 ejects the ink both in a process of moving in the +X direction and in a process of moving in the −X direction using the carriage 32.

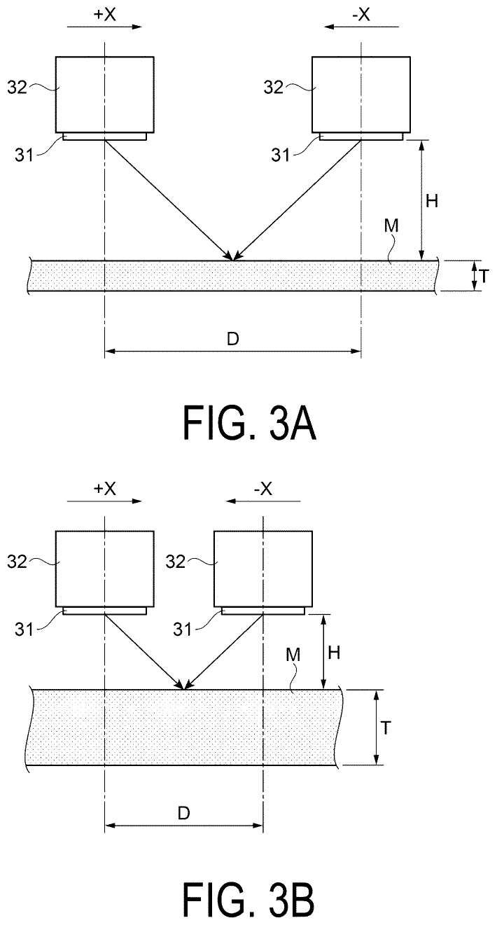

Here, as shown in FIG. 3A, since the ejection head 31 is spaced apart from the medium M and ejects the ink while moving in the X-axis direction, the ejected ink lands on the medium M following an oblique trajectory. To this end, even when the ejection head 31 ejects the ink from the same position, the landing position of the ink is different between a case where the ejection head 31 moves in the +X direction and a case where the ejection head 31 moves in the −X direction. Therefore, the controlling unit 90 of the present embodiment adjusts the landing position of the ink by adjusting a timing at which the ink is ejected when the carriage 32 moves in the +X direction and a timing at which the ink is ejected when the carriage 32 moves in the −X direction. The adjustment amount for adjusting the ejection timing can be represented by, for example, a position at which the ejection head 31 should eject ink, that is, a distance D between the ejection positions of the ejection head 31 in order to land the ink at the same position in both a case of moving in the +X direction and a case of moving in the −X direction. The adjustment amount for adjusting the ejection timing corresponds to the adjustment amount for adjusting the landing position of the liquid.

Further, as shown in FIGS. 3A and 3B, the landing position of the ink also varies depending on a distance H between the ejection head 31 and the medium M. For example, as the distance H between the ejection head 31 and the medium M increases, a time from the ejection of the ink to the landing of the ink increases, and a distance between the ejection position and the landing position also increases. Therefore, the controlling unit 90 changes the adjustment amount of the ejection timing depending on the distance H between the ejection head 31 and the medium M. Specifically, when a height of the ejection head 31 is fixed, the distance H between the ejection head 31 and the medium M changes depending on a thickness T of the medium M, and thus the controlling unit 90 of the present embodiment changes the adjustment amount of the ejection timing depending on the thickness T of the medium M.

As illustrated in FIG. 2, a first detection unit 41 that detects the presence or absence of the medium M and a second detection unit 42 that detects the thickness of the medium M are disposed in the carriage 32. Specifically, the first detection unit 41 is attached to the side surface on the +X side of the carriage 32, and the second detection unit 42 is attached to the +X side of the first detection unit 41. That is, the ejection head 31, the first detection unit 41, and the second detection unit 42 are attached to the carriage 32 in this order in the +X direction. However, a positional relationship between the ejection head 31, the first detection unit 41, and the second detection unit 42 is not limited to the above.

The first detection unit 41 includes a reflective optical sensor, and detects whether or not the medium M is present in the −Z direction by emitting light in the −Z direction and receiving reflected light. It is assumed that the color of the glue belt 22 is dark, while the color of the medium M is light. That is, the color of the glue belt 22 is different from the color of the medium M. To this end, the received light amount of the reflected light is different between a case where the glue belt 22 is irradiated with the light emitted from the first detection unit 41 and a case where the medium M is irradiated with the light. That is, the first detection unit 41 detects the presence or absence of the medium M based on the received light amount of the reflected light. Further, the first detection unit 41 can detect the end portion of the medium M by detecting the presence or absence of the medium M while moving in the X-axis direction together with the carriage 32.

The second detection unit 42 detects the thickness of the medium M. The second detection unit 42 is, for example, an ultrasonic sensor, and is capable of detecting a distance to the medium M based on a time required from transmission to reception of an ultrasonic wave. The second detection unit 42 can detect the thickness of the medium M based on the distance to the medium M.

As shown in FIG. 1, after the printed medium M is peeled off from the glue belt 22, the glue belt 22 is folded back by the driving roller 24 and moves along the transport preparation path. When a pattern or the like is printed on the medium M such as a fabric, ink that has passed through the medium M, ink that protrudes from the end portion of the medium M in the X-axis direction, a fiber that has fallen off from the medium M, or the like is adhered to the outer circumferential surface 22A of the glue belt 22.

The cleaning unit 70 cleans the glue belt 22 moving on the transport preparation path with a cleaning liquid to remove ink, fiber, and the like attached to the outer circumferential surface 22A of the glue belt 22. Specifically, the cleaning unit 70 is disposed below the driving roller 24 side with respect to the arrangement position of the endless glue belt 22, and cleans the outer circumferential surface 22A of the glue belt 22 from below.

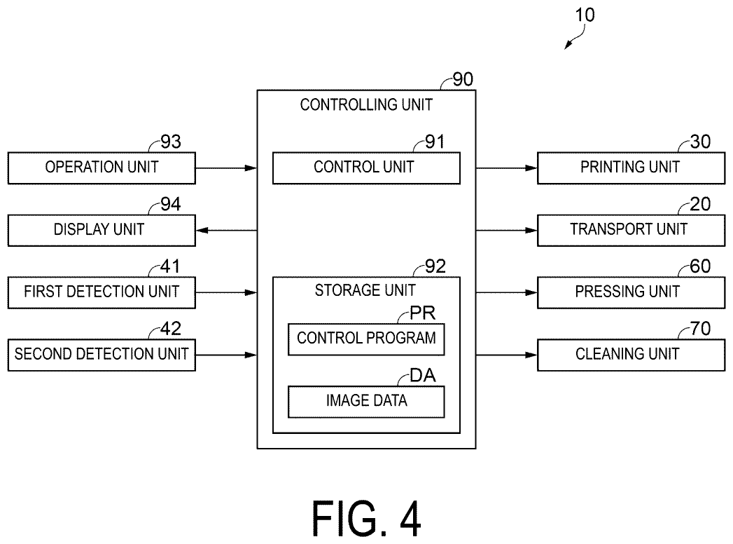

FIG. 4 is a block diagram showing an electrical configuration of the printer 10.

As illustrated in FIG. 4, the controlling unit 90 is configured of a computer, for example, and includes a control unit 91, a storage unit 92.

The control unit 91 includes a Central Processing Unit (CPU; not illustrated) that is a processor, and a memory. The memory is a storage apparatus in which an area for storing a program, a working area, and the like are secured, and includes a random access memory (RAM), an electrically erasable programmable read-only memory (EEPROM), the like. The CPU controls the operation of each unit of the printer 10 according to a control program PR read from the storage unit 92 to the memory.

The storage unit 92 is configured of a nonvolatile storage apparatus and stores the control program PR described above, image data DA, and the like.

The printing unit 30, the transport unit 20, the pressing unit 60, and the cleaning unit 70 described above are electrically coupled to the controlling unit 90, and the controlling unit 90 controls an operation of each of components constituting these units.

For example, the controlling unit 90 controls the ejection head 31 constituting the printing unit 30 as described above. Specifically, the controlling unit 90 is coupled to a drive circuit (not illustrated) of the ejection head 31, and transmits a print signal for ejecting the ink from the ejection head 31 to the drive circuit. Further, the controlling unit 90 controls a carriage motor (not illustrated) which is a driving source for moving the carriage 32 in the X-axis direction.

Further, the controlling unit 90 controls each of a transport motor (not illustrated) which is a driving source of the driving roller 24 constituting the transport unit 20, a pressing roller driving unit (not illustrated) constituting the pressing unit 60, and a driving source (not illustrated) of the cleaning unit 70.

Further, the first detection unit 41 and the second detection unit 42 described above are electrically coupled to the controlling unit 90. The first detection unit 41 detects the presence or absence of the medium M based on the control of the controlling unit 90 and outputs a detection result to the controlling unit 90. Similarly, the second detection unit 42 detects the thickness of the medium M based on the control of the controlling unit 90 and outputs a detection result to the controlling unit 90.

The printer 10 further includes an operation unit 93 and a display unit 94, which are also electrically coupled to the controlling unit 90. The operation unit 93 is configured of operation buttons, a touch panel, or the like, receives an input operation from a user, and outputs an operation signal corresponding to the input operation to the controlling unit 90. For example, the operation unit 93 receives printing conditions or various kinds of instruction information from the user. The display unit 94 notifies the user of various kinds of information by displaying images, characters, and the like under the control of the controlling unit 90. The display unit 94 may be configured to notify the user of various kinds of information by performing communication with a communication terminal apparatus such as a smartphone.

The printer 10 configured as described above is assumed to execute printing on a large-sized medium M, that is, the medium M that is long and wide in the transport direction. However, prior to printing on a large medium M, a sample for selecting an appropriate medium M from among various types of media M may be created by the printer 10. Since such a sample may have a relatively small size, it is desirable to collectively execute printing on a plurality of small pieces of the medium M in consideration of productivity of the sample. In the printer 10 according to the present embodiment, it is possible to adjust the ejection timing depending on the thickness of each of the plurality of media M arranged on the glue belt 22 with respect to the plurality of media M, and collectively perform the printing.

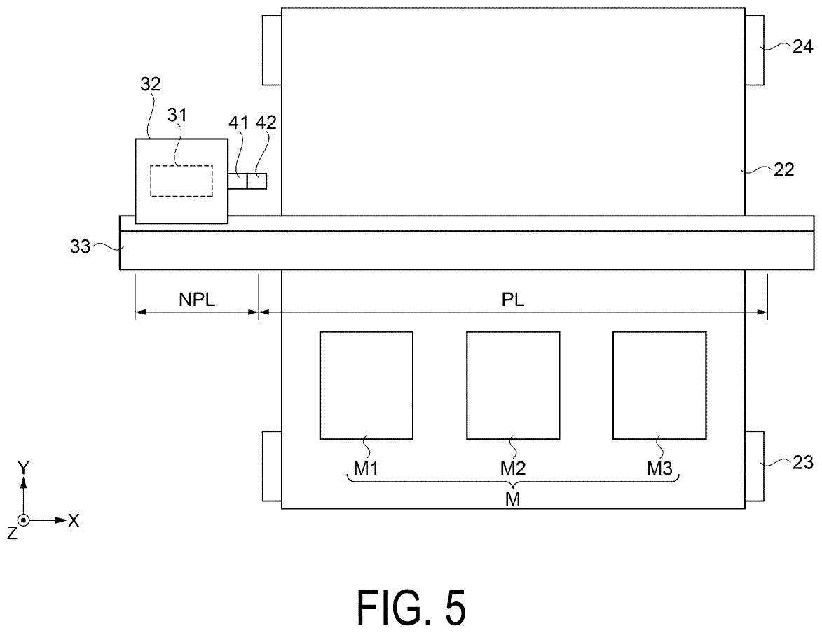

FIG. 5 is a plan view illustrating a state in which three media M1 to M3 which are small pieces of media M are arranged on the glue belt 22 as an example.

When printing is collectively performed on a plurality of small pieces of media M1 to M3, the medium M1 to M3 are arranged on the glue belt 22 along the X-axis by the user as illustrated in FIG. 5, for example. The media M1 to M3 are made of different types of materials and are not the same in thicknesses. However, the medium M1 to M3 are all formed to have the same shape and the same size, and are orderly arranged on the glue belt 22 along the X-axis in a state in which directions are aligned. The shapes of the medium M1 to M3 are, for example, rectangular.

The plurality of media M1 to M3 are disposed, for example, on the −Y side of the carriage guide 33, that is, on the upstream in the transport direction. Thereafter, the medium M1 to M3 are transported in the +Y direction, and when the end portion on the +Y side of the medium M1 to M3 reaches a position intersecting a movement path of the ejection head 31, the user causes the printer 10 to start printing on the medium M1 to M3. It is assumed that the carriage 32 is located in the retraction region NPL before the start of printing.

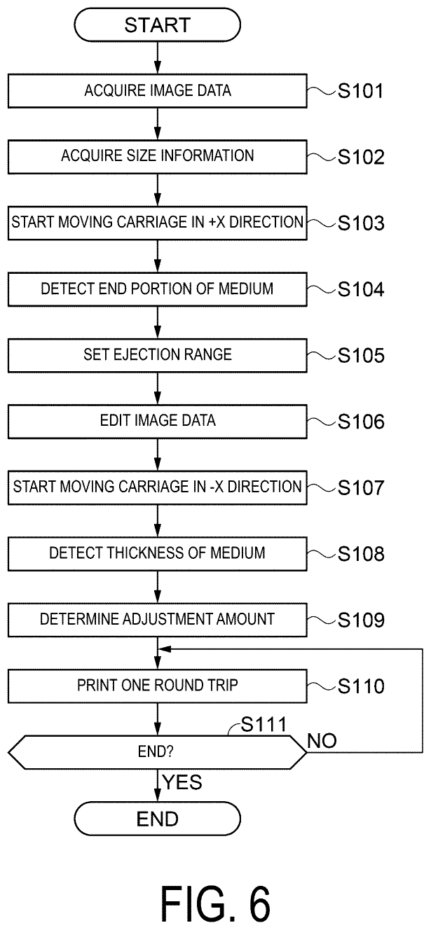

FIG. 6 is a flowchart for describing a printing operation of the printer 10, that is, a liquid ejection method using the printer 10.

As shown in FIG. 6, first, in step S101, the control unit 91 of the printer 10 acquires the image data DA from the storage unit 92. The image data DA is image data representing an image such as a pattern to be printed on the medium M. However, since the image data DA is image data assumed to be printed on the large medium M, the image data DA is image data corresponding to a size larger than the individual sizes of the small pieces of the medium M1 to M3.

In step S102, the control unit 91 acquires size information of the medium M1 to M3. The size information is input by the user via the operation unit 93, for example. The size information includes information indicating the sizes of the medium M1 to M3, information indicating directions of the medium M arranged on the glue belt 22, and the like.

In step S103, the control unit 91 controls the printing unit 30 so that the movement of the carriage 32 in the +X direction starts.

In step S104, the control unit 91 causes the first detection unit 41 to detect the end portions of the plurality of media M1 to M3 arranged on the glue belt 22 in a process in which the carriage 32 moves from the retraction region NPL to the end of the printable region PL in the +X direction. Specifically, the control unit 91 causes the end portion on the −X side and the end portion on the +X side of each medium M to be detected. Accordingly, the control unit 91 can recognize the number of media M disposed in the X-axis direction and each position.

After the carriage 32 moves to the end of the printable region PL in the +X direction, the control unit 91 sets, in step S105, the ejection range for each of the medium M1 to M3 based on the size information acquired in step S102 and the detection result of the end portion in step S104. The ejection range is a range in which the ink is ejected from the ejection head 31, and is set to be smaller than a range in which the medium M1 to M3 are detected, in order to curb the ejection of the ink to the outside of the medium M1 to M3.

In step S106, the control unit 91 edits the image data DA according to the set ejection range. To be specific, the control unit 91 performs processing of trimming an area outside the ejection range on the image data DA acquired in step S101 to generate an edited image data which is image data after the processing.

In step S107, the control unit 91 controls the printing unit 30 so that movement of the carriage 32 in the −X direction starts.

In step S108, the control unit 91 causes the second detection unit 42 to detect the thicknesses of the plurality of media M1 to M3 arranged on the glue belt 22 in a process in which the carriage 32 moves in the −X direction. For example, the control unit 91 causes a thickness at a center positions in the X-axis direction of each of the medium M1 to M3 to be detected based on the positions of the end portions of the medium M1 to M3 detected in step S104. The control unit 91 may cause the second detection unit 42 to detect thicknesses at a plurality of positions of each of the medium M1 to M3 and obtain a mean value of these values.

In step S109, the control unit 91 determines an adjustment amount for adjusting the ejection timing for each of the medium M1 to M3 based on the detection result in step S108. To be specific, a table (not illustrated) in which the thicknesses of the medium M1 to M3 and the adjustment amounts are associated with each other is stored in the storage unit 92 in advance, and the control unit 91 determines the adjustment amount of the ejection timing based on the detected thicknesses of the medium M1 to M3 and the table.

After the carriage 32 moves to the end of the printable region PL in the −X direction, the control unit 91 controls the printing unit 30 to execute printing for one round trip on the medium M1 to M3 in step S110. That is, the control unit 91 causes the ink to be ejected from the ejection head 31 based on the edited image data while moving the carriage 32 in the +X direction, and causes the ink to be ejected from the ejection head 31 based on the edited image data while moving the carriage 32 in the −X direction. In this case, the timing at which the ink is ejected when the carriage 32 moves in the +X direction and a timing at which the ink is ejected when the carriage 32 is moving in the −X direction are adjusted according to the adjustment amount for each of the medium M1 to M3. That is, the control unit 91 adjusts the landing position based on the adjustment amount determined for each of the medium M1 to M3, and causes the ink to be ejected from the ejection head 31 to the ejection range of the plurality of media M1 to M3. Therefore, in all the medium M1 to M3, the deviation of the landing position caused by the bi-directional printing is curbed.

In step S111, the control unit 91 repeatedly determines whether printing based on the edited image data has all ended. When the printing does not yet end (step S111: NO), the control unit 91 transports the medium M1 to M3 in the +Y direction by a predetermined amount, then returns the processing to step S110 to execute printing for one more round trip, and repeats step S110 until all printing ends. On the other hand, when the printing based on the edited image data has all ended (step S111: YES), the control unit 91 executes predetermined termination processing and then ends the printing operation.

As described above, according to the printer 10 and liquid ejection method of the present embodiment, the following effects can be obtained.

According to the present embodiment, the control unit 91 determines the adjustment amount for adjusting the landing position of the ink for each medium M based on a detection result of the second detection unit 42 which detects the thickness of the medium M. Accordingly, it is possible to adjust the landing position of the ink with the adjustment amount suitable for each thickness with respect to the plurality of media M arranged on the glue belt 22, and thus to curb the deviation of the landing position in the bidirectional printing for each medium M. Further, since the ejection range of the ink is set based on the detection result of the first detection unit 41 which detects the end portion of the medium M, it is possible to curb the ink from being ejected to the outside of the medium M.

According to the present embodiment, since the first detection unit 41 and the second detection unit 42 are mounted on the carriage 32, it is easy to detect the end portion or the thickness of the medium M in the X-axis direction.

According to the present embodiment, since the color of the glue belt 22 is different from the color of the medium M, it is possible to accurately detect the end portion of the medium M using the first detection unit 41 which is the reflective optical sensor.

### 2. Second Embodiment

Hereinafter, a printer 10 of a second embodiment will be described with reference to the drawings. Since the printer 10 of the present embodiment has the same hardware configuration as the printer 10 of the first embodiment, description thereof will be omitted. In the second embodiment, an operation when printing is performed on a small piece of the medium M is different from that in the first embodiment.

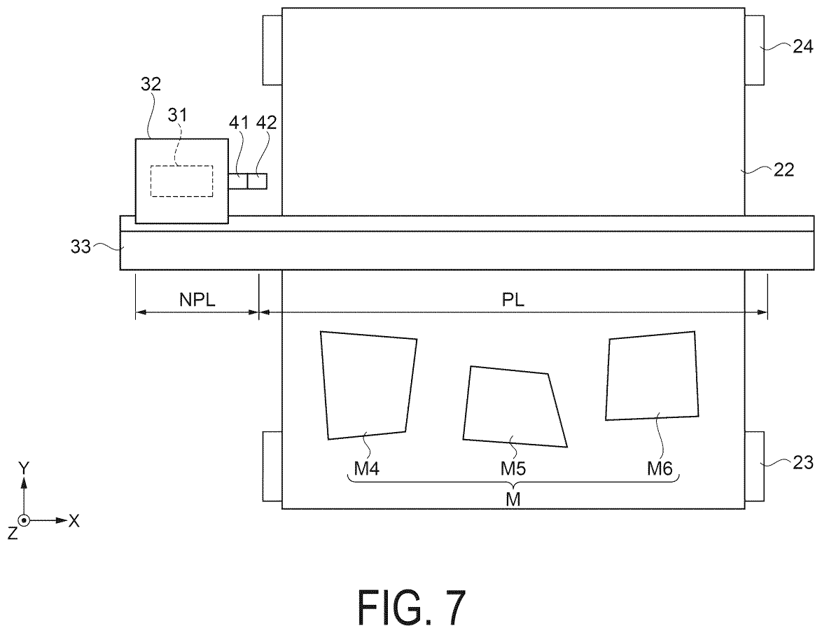

FIG. 7 is a plan view illustrating a state in which three media M4 to M6 which are small pieces of media M are arranged on the glue belt 22.

When printing is collectively performed on a plurality of small pieces of media M4 to M6, the medium M4 to M6 are arranged on the glue belt 22 along the X-axis by the user as illustrated in FIG. 7, for example. The media M4 to M6 are made of different types of materials and are not the same in thicknesses. Further, in the present embodiment, scraps are used as the medium M4 to M6, and shapes or sizes of the medium M4 to M6 are not unified.

The plurality of media M4 to M6 are disposed, for example, on the −Y side of the carriage guide 33, that is, on the upstream side in the transport direction. Thereafter, the medium M4 to M6 are transported in the +Y direction, and when an end portion on the +Y side of at least one of the medium M4 to M6 reaches the position intersecting the movement path of the ejection head 31, the user causes the printer 10 to start printing on the medium M4 to M6. It is assumed that the carriage 32 is located in the retraction region NPL before the start of printing.

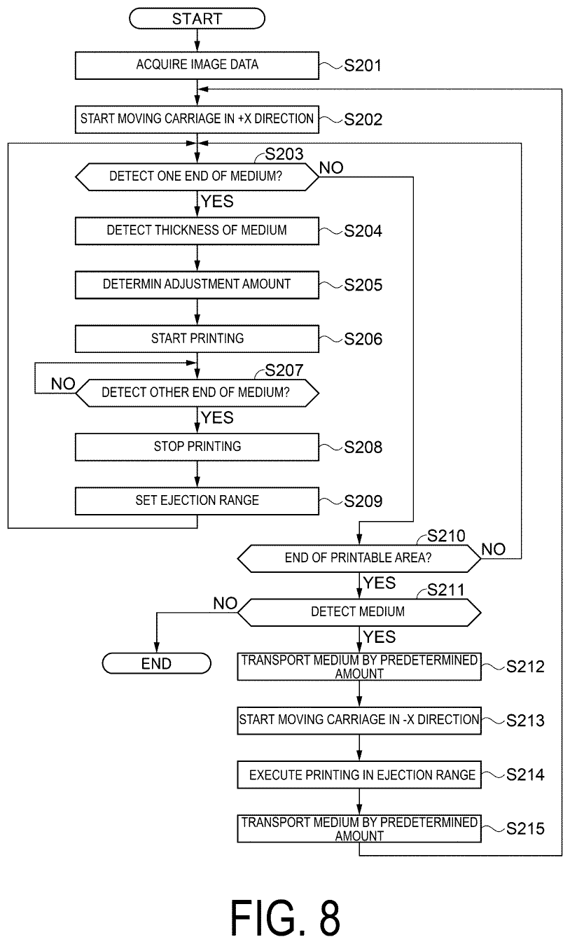

FIG. 8 is a flowchart illustrating a printing operation of the printer 10 according to the second embodiment, that is, a liquid ejection method using the printer 10.

As shown in FIG. 8, first, in step S201, the control unit 91 of the printer 10 acquires the image data DA from the storage unit 92. The image data DA is image data representing an image such as a pattern to be printed on the medium M, and is image data in which printing on a large-sized medium M is assumed.

In step S202, the control unit 91 controls the printing unit 30 so that the movement of the carriage 32 in the +X direction starts. The control unit 91 causes the first detection unit 41 to detect the end portion of the medium M while moving the carriage 32 in the +X direction.

In step S203, the control unit 91 determines whether or not one end of any of the medium M, that is, the end portion on the −X side is detected by the first detection unit 41 in a process in which the carriage 32 moves in the +X direction. The control unit 91 moves the processing to step S204 when one end of the medium M is detected (step S203: YES), and moves the processing to step S210 when the one end of the medium M is not detected (step S203: NO).

When one end of the medium M is detected and the processing proceeds to step S204, the control unit 91 causes the second detection unit 42 to detect the thicknesses of the detected media M.

In step S205, the control unit 91 determines the adjustment amount of the ejection timing depending on the thicknesses of the medium M.

In step S206, the control unit 91 starts printing based on the image data DA at a timing when the carriage 32 moves in the +X direction by a predetermined amount from the position of the detected one end.

In step S207, the control unit 91 determines whether or not the other end of the medium M, that is, the end portion on the +X side is detected by the first detection unit 41 in a process in which the ejection head 31 performs printing while moving in the +X direction. When the other end of the medium M is detected (step S207: YES), the control unit 91 moves the processing to step S208. On the other hand, when the other end of the medium M has not been detected (step S207: NO), the control unit 91 repeats step S207 and continues printing while moving in the +X direction until the other end of the medium M is detected.

When the other end of the medium M is detected and the processing proceeds to step S208, the control unit 91 stops printing, that is, ink ejection, before the position of the detected other end.

In step S209, the control unit 91 sets a range from a position at which printing starts in step S206 to a position at which printing stops in step S208 as the ejection range, and stores the ejection range in the storage unit 92. Thereafter, the control unit 91 returns the processing to step S203 while maintaining a state in which the carriage 32 moves in the +X direction. A determination is made as to whether or not one end of the next medium M is detected, and thereafter, the above-described operation is repeated.

When the one end of the medium M is not detected in step S203 and the processing proceeds to step S210, the control unit 91 determines whether or not the carriage 32 has reached the end of the printable region PL in the +X direction. The control unit 91 moves the processing to step S211 when the carriage 32 has reached the end of the printable region PL in the +X direction (step S210: YES), and returns the processing to step S203 when the carriage 32 has not reached the end of the printable region PL in the +X direction (step S210: NO).

When the carriage 32 has reached the end of the printable region PL in the +X direction and the processing proceeds to step S211, the control unit 91 determines whether at least one medium M has been detected in the printable region PL. When the at least one medium M is detected (step S211: YES), the control unit 91 moves the processing to step S212. On the other hand, when none of the medium M is detected in the printable region PL (step S211: NO), the control unit 91 determines that printing has been completed, performs predetermined termination processing, and then ends the printing operation. When the at least one medium M is detected before the carriage 32 reaches the end of the printable region PL in the +X direction, the adjustment amount of the ejection timing is determined for each detected medium M, and the ejection range is set for each detected medium M.

When the at least one medium M is detected in the printable region PL and the processing proceeds to step S212, the control unit 91 controls the transport unit 20 so that the medium M is transported in the +Y direction by a predetermined amount.

In step S213, the control unit 91 controls the printing unit 30 so that movement of the carriage 32 in the −X direction starts.

In step S214, the control unit 91 controls the printing unit 30 so that the printing is executed in the respective ejection ranges with respect to all the medium M detected in the forward path while moving the carriage 32 in the −X direction. In this printing, the ejection timing is adjusted based on the adjustment amount determined for each medium M. That is, the control unit 91 adjusts the landing position based on the adjustment amount determined for each of the medium M4 to M6, and causes the ink to be ejected to the ejection range of the plurality of media M4 to M6 from the ejection head 31.

After the carriage 32 reaches the end of the printable region PL in the −X direction, the control unit 91 controls the transport unit 20 so that the medium M is transported in the +Y direction by a predetermined amount in step S215. The processing returns to step S202, and the above operation is repeated until the medium M is no longer detected in step S211.

As described above, according to the printer 10 and liquid ejection method of the present embodiment, it is possible to obtain the same effects as those in the first embodiment.

Further, according to the present embodiment, since the ejection range is reset each time printing for one round trip is executed, it is possible to print an image in an appropriate range even when a size or a shape of the medium M is not uniform or when an arrangement of the plurality of media M is disturbed.

Each of the embodiments may be modified as follows.

The medium M is not limited to fabric. Examples of the medium M include a resin material such as polyurethane, polyethylene, polypropylene, polyester, polyamide, and acrylic resin, paper, glass, metal, ceramics, leather, wood, and ceramic, various natural fibers, synthetic fibers, or semi-synthetic fibers such as a fiber, silk, wool, cotton, linen, polyester, polyamide (nylon), acrylic, polyurethane, cellulose, linter, rayon, cupra, or acetate composed of at least one of the above, or may be one material or a material obtained by combing two or more materials selected from these materials.

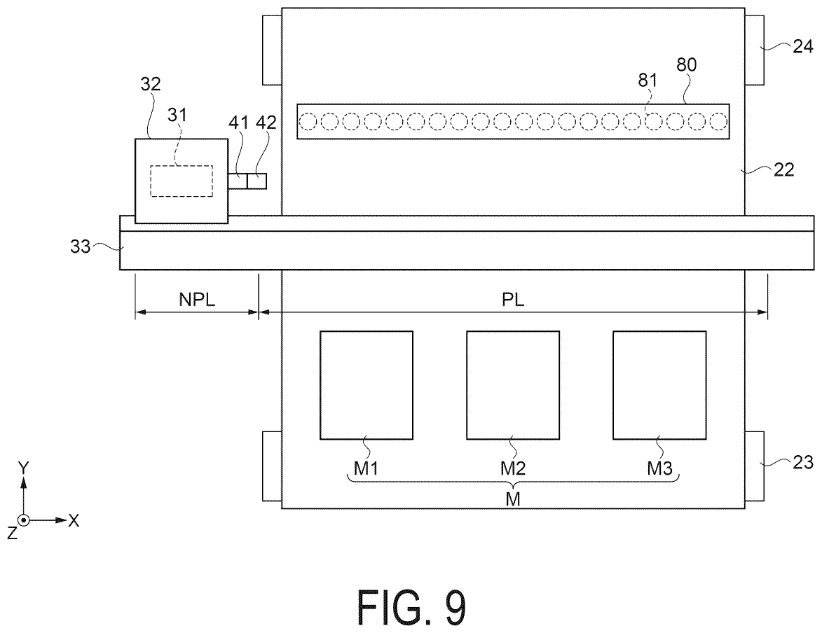

In each of the embodiments, the drying unit 80 that dries the medium M onto which the ink is ejected from the ejection head 31 may be provided downstream of the carriage 32 in the transport direction. As shown in FIG. 9, the drying unit 80 includes, for example, a plurality of heating bodies 81 arranged along the X-axis. The control unit 91 sets the heating body 81 to be turned on using the drying unit 80 based on the detection result of the first detection unit 41. To be specific, the control unit 91 turns on the heating bodies 81 at positions corresponding to regions where the medium M1 to M3 are arranged, and turns off the other heating bodies. According to this configuration, since a drying range is set depending on a position of the medium M, it is possible to efficiently dry the medium M. Further, in this configuration, the control unit 91 may determine a parameter for drying the plurality of media M1 to M3 based on the detection result of the second detection unit 42, that is, the thicknesses of the medium M. The parameters may include, for example, a set temperature of the heating body 81, a drying time, that is, a time during which the heating body 81 is turned on. Further, when the thickness of the medium M is relatively large, it is possible to increase the set temperature or lengthen the drying time compared to a case where the thickness of the medium M is relatively small. According to this configuration, since a parameter for drying is determined depending on the thickness of the medium M, it is possible to more efficiently dry the medium M.

In each of the embodiments, the control unit 91 may set the ejection range and then cause the display unit 94 to display the set ejection range in step S105 or step S209. According to this configuration, the user can confirm whether or not the set ejection range is appropriate.

The control unit 91 may be able to switch between a first operation state in which the operation of the first embodiment described above is performed and a second operation state in which the operation of the second embodiment described above is performed. Here, as shown in FIG. 6, the first operation state is an operation state in which, after the ejection range is set once in step S105, the operation of step S110 in which the ejection head 31 is reciprocated once while the ink is ejected from the ejection head 31 is repeated a plurality of times. On the other hand, the second operation state is an operation state in which the ejection range is set in step S209 each time the operation of steps S202 to S215 in which the ejection head 31 reciprocates once while ejecting the ink from the ejection head 31 is performed, as shown in FIG. 8. According to this configuration, since the control unit 91 can switch between a first operation state in which a frequency at which the ejection range is set is relatively low and a second operation state in which the frequency at which the ejection range is set is relatively high, it is possible to select an appropriate operation state according to a shape or size of the medium M, an inclination of the medium M, or the like.

In the second embodiment, at least the first detection unit 41 may be disposed on both sides of the ejection head 31 in the #X direction, and the ejection range may be set in both the forward path and the backward path. According to this configuration, since the frequency at which the ejection range is set is higher, it is possible to print an image in a more appropriate range.

In each of the embodiments, the first detection unit 41 and the second detection unit 42 are not limited to the configurations described above, and the end portion or the thickness of the medium M may be able to be detected. Further, the present disclosure is not limited to a configuration in which the first detection unit 41 and the second detection unit 42 are separately included, and the first detection unit 41 and the second detection unit 42 may be common. That is, one sensor may constitute both of the first detection unit 41 and the second detection unit 42. For example, an ultrasonic sensor capable of detecting the thickness of the medium M may be used to detect the end portion of the medium M based on a change in thickness.

In each of the embodiments, a configuration in which printing is performed on the medium M disposed on the endless glue belt 22 is described, but the configuration of the printer 10 is not limited thereto. For example, a configuration may be adopted in which printing is performed on the medium M disposed on a long transport body having adhesiveness on one side, such as an adhesive tape. The transport body, for example, may be installed in the printer 10 as a roll body wound in a roll shape. The transport body unwound from the roll body may be wound into a roll shape again via the printable region PL. In this configuration, the medium M is disposed on an adhesive surface of the transport body, and the ink is ejected from the ejection head 31 to the medium M supported by the transport body in the printable region PL. Therefore, in this configuration, the transport body corresponds to the support member.

In each of the embodiments, in order to adjust the landing position of the ink in the bidirectional printing, the ejection timing of the ink is adjusted depending on the thickness of the medium M, but the present disclosure is not limited to this configuration. For example, the landing position of the ink may be adjusted through adjustment of the height of the ejection head 31 depending on the thickness of the medium M. Specifically, the ejection head 31 may be configured to be able to be displaced in a vertical direction depending on a rotation angle of a cam, and the control unit 91 may rotate the cam so that the ejection head 31 is at a height depending on the thickness of the medium M. In this case, the height of the ejection head 31 or the rotation angle of the cam corresponds to the adjustment amount for adjusting the landing position of the liquid.

Hereinafter, the content derived from the embodiments will be described below.

A liquid ejection apparatus includes a support member on which a plurality of different types of media are arranged, an ejection head configured to eject liquid onto the plurality of media while reciprocating along a first direction, a first detection unit configured to detect an end portion of the medium arranged on the support member, a second detection unit configured to detect a thickness of the medium arranged on the support member, and a control unit, wherein the control unit includes causes the first detection unit to detect an end portion of each of the plurality of media, sets an ejection range in which the liquid is ejected for each medium based on a detection result of the first detection unit, causes the second detection unit to detect a thickness of each of the plurality of media, and determine an adjustment amount for adjusting the landing position of the liquid for each medium based on a detection result of the second detection unit, and adjusts the landing position based on the adjustment amount and causes the liquid to be ejected in the ejection ranges of the plurality of media from the ejection head.

According to this configuration, the control unit determines the adjustment amount for adjusting the landing position of the liquid for each medium based on the detection result of the second detection unit that detects the thickness of the medium. This makes it possible to adjust the landing position of the liquid with the adjustment amount suitable for each thickness with respect to the plurality of media arranged on the support member, and thus to curb the deviation of the landing position in the bidirectional printing for each medium. Further, since the ejection range of the liquid is set based on the detection result of the first detection unit which detects the end portion of the medium, it is possible to curb the liquid from being ejected to the outside of the medium.

It is preferable that the liquid ejection apparatus further includes a carriage that reciprocates in the first direction, and the ejection head, the first detection unit, and the second detection unit are disposed in the carriage.

According to this configuration, since the first detection unit and the second detection unit are mounted on the carriage, it is easy to detect the end portion or the thickness of the medium in the first direction.

In the liquid ejection apparatus, it is preferable that the control unit is able to switch between a first operation state in which an operation of causing the ejection head to reciprocate once while ejecting the liquid from the ejection head is repeated a plurality of times after the ejection range is set, and a second operation state in which the ejection range is set each time the ejection head reciprocates once while ejecting the liquid from the ejection head.

According to this configuration, since the control unit can switch between the first operation state in which the frequency at which the ejection range is set is relatively low and the second operation state in which the frequency at which the ejection range is set is relatively high, it is possible to select an appropriate operation state according to the shape or size of the medium, the inclination of the medium, or the like.

It is preferable that the liquid ejection apparatus further includes a display unit configured to display the ejection range set by the control unit.

According to this configuration, since the display unit is included, it is possible to confirm whether or not the set ejection range is appropriate.

In the liquid ejection apparatus, it is preferable that the first detection unit is a reflective optical sensor, and a color of the support member is different from a color of the plurality of media.

According to this configuration, since the color of the support member is different from the color of the medium, it is possible to accurately detect the end portion of the medium using the reflective optical sensor.

It is preferable that the liquid ejection apparatus includes a drying unit configured to dry the plurality of media onto which the liquid is ejected, wherein the control unit sets a drying range based on the detection result of the first detection unit.

According to this configuration, since the drying range is set depending on the position of the medium, it is possible to efficiently dry the medium.

In the liquid ejection apparatus, it is preferable that the control unit determines a parameter for drying the plurality of media based on the detection result of the second detection unit.

According to this configuration, since the parameter for drying is determined depending on the thickness of the medium, it is possible to more efficiently dry the medium.

A liquid ejection method is a liquid ejection method using a liquid ejection apparatus including an ejection head configured to eject liquid onto a plurality of different types of media arranged on a support member while reciprocating in a first direction, a first detection unit configured to detect an end portion of the media arranged on the support member, and a second detection unit configured to detect a thickness of the media arranged on the support member, the liquid ejection method including: causing the first detection unit to detect an end portion of each of the plurality of media; setting an ejection range in which the liquid is ejected for each medium based on a detection result of the first detection unit; causing the second detection unit to detect a thickness of each of the plurality of media; determining an adjustment amount for adjusting a landing position of the liquid for each medium based on a detection result of the second detection unit; and adjusting the landing position based on the adjustment amount and causing the liquid to be ejected onto the ejection ranges of the plurality of media from the ejection head.

According to this configuration, the adjustment amount for adjusting the landing position of the liquid is determined for each medium based on the detection result of the second detection unit that detects the thickness of the medium. This makes it possible to adjust the landing position of the liquid with the adjustment amount suitable for each thickness with respect to the plurality of media arranged on the support member, and thus to curb the deviation of the landing position in the bidirectional printing for each medium. Further, since the ejection range of the liquid is set based on the detection result of the first detection unit which detects the end portion of the medium, it is possible to curb the liquid from being ejected to the outside of the medium.

What is claimed is:

1. A liquid ejection apparatus comprising:
a support member on which a plurality of different types of media are arranged,
an ejection head configured to eject liquid onto the plurality of media while reciprocating along a first direction,
a first detection unit configured to detect an end portion of the medium arranged on the support member, and
a second detection unit configured to detect a thickness of the medium arranged on the support member, and
a control unit, wherein
the control unit
causes the first detection unit to detect an end portion of each of the plurality of media,
sets an ejection range in which the liquid is ejected for each medium based on a detection result of the first detection unit,
causes the second detection unit to detect a thickness of each of the plurality of media, and
determines an adjustment amount for adjusting a landing position of the liquid for each medium based on a detection result of the second detection unit, and
adjusts the landing position based on the adjustment amount and causes the liquid to be ejected in the ejection ranges of the plurality of media from the ejection head.

2. The liquid ejection apparatus according to claim 1, comprising:
a carriage configured to reciprocate in the first direction, wherein
the ejection head, the first detection unit, and the second detection unit are disposed in the carriage.

3. The liquid ejection apparatus according to claim 1, wherein
the control unit is configured to switch between
a first operation state in which an operation of causing the ejection head to reciprocate once while ejecting the liquid from the ejection head is repeated a plurality of times after the ejection range is set, and
a second operation state in which the ejection range is set each time the ejection head reciprocates once while ejecting the liquid from the ejection head.

4. The liquid ejection apparatus according to claim 1, further comprising a display unit configured to display the ejection range set by the control unit.

5. The liquid ejection apparatus according to claim 1, wherein
the first detection unit is a reflective optical sensor, and
a color of the support member is different from colors of the plurality of media.

6. The liquid ejection apparatus according to claim 1, comprising:
a drying unit configured to dry the plurality of media onto which the liquid is ejected, wherein
the control unit sets a drying range based on the detection result of the first detection unit.

7. The liquid ejection apparatus according to claim 6, wherein the control unit determines a parameter for drying the plurality of media based on the detection result of the second detection unit.

8. A liquid ejection method using a liquid ejection apparatus including an ejection head configured to eject liquid onto a plurality of different types of media arranged on a support member while reciprocating in a first direction, a first detection unit configured to detect an end portion of the media arranged on the support member, and a second detection unit configured to detect a thickness of the media arranged on the support member, the liquid ejection method comprising:
causing the first detection unit to detect an end portion of each of the plurality of media;
setting an ejection range in which the liquid is ejected for each medium based on a detection result of the first detection unit;
causing the second detection unit to detect a thickness of each of the plurality of media;
determining an adjustment amount for adjusting a landing position of the liquid for each medium based on a detection result of the second detection unit; and
adjusting the landing position based on the adjustment amount and causing the liquid to be ejected onto the ejection ranges of the plurality of media from the ejection head.
